(19) United States
(12) Patent Application Publication
(10) Pub. No.: US 2013/0305176 A1
(43) Pub. Date: Nov. 14, 2013

(54) UI CREATION SUPPORT SYSTEM, UI CREATION SUPPORT METHOD, AND NON-TRANSITORY STORAGE MEDIUM

(71) Applicants: Ryosuke Okubo, Tokyo (JP); Shunsuke Suzuki, Tokyo (JP); Yukiko Tanikawa, Tokyo (JP)

(72) Inventors: Ryosuke Okubo, Tokyo (JP); Shunsuke Suzuki, Tokyo (JP); Yukiko Tanikawa, Tokyo (JP)

(73) Assignee: NEC CORPORATION, Tokyo (JP)

(21) Appl. No.: 13/981,225

(22) PCT Filed: Nov. 29, 2011
(86) PCT No.: PCT/JP2011/006631

§ 371 Date: Jul. 23, 2013

(30) Foreign Application Priority Data
Jan. 27, 2011 (JP) 2011-015235

(51) Int. Cl. G06F 3/0481

(52) U.S. Cl. CPC G06F 3/0481
USPC 715/765

(57) ABSTRACT

In order to adjust an amount of information to be simultaneously displayed on a display with identity of information to be displayed on a user interface (UI) screen guaranteed and to design a UI screen suitable for an assumed user, a UI creation support system (1) is provided which supports creating a UI screen for a predetermined service in which a plurality of user interface (UI) components are arranged, the UI creation support system (1) including a UI configuration determining unit (10) configured to determine a configuration of the UI screen, which includes all the plurality of UI components, for an assumed user using the UI screen according to the assumed user by adjusting the number of the UI components to be simultaneously displayed on a display.

### TECHNICAL FIELD

The present invention relates to a UI creation support system, a UI creation support method, and a program.

### BACKGROUND ART

A designer of a UI screen needs to understand how a user (hereinafter, referred to as an “assumed user”) will use the UI screen and to design the UI screen suitable for the assumed user. However, it is not easy to design a UI screen suitable for an assumed user.

Patent Document 1 discloses a technique of choosing components to be arranged on a UI screen according to a user and creating a UI screen for the user in which only the selected components are arranged.

Patent Document 2 discloses a technique of choosing help information to be provided according to a user and displaying only the selected help information on a display unit in a system having a function of providing the help information when the help information is requested by the user.

Patent Document 3 discloses an information processing terminal that calculates the sizes or the display positions of graphical user interface (GUI) components on a screen and displays the GUI components on the basis of the calculation details when an application of displaying the GUI components corresponding to different devices including keys or a display for the purpose of creating UI screens corresponding to mobile terminals having the different devices mounted thereon.

Patent Document 4 discloses a system that displays, edits, and processes multi-dimensional data efficiently, compactly, and in real time using an intuitive GUI without extensive user training, in which edition (deletion and the like) of “events” included in basic data elements of a data structure displayed by the GUI can be performed by a user.

### RELATED DOCUMENT

### Patent Document

[Patent Document 1] Japanese Unexamined Patent Publication No. 2004-355418
[Patent Document 2] Japanese Unexamined Patent Publication No. 2001-117688
[Patent Document 3] Japanese Unexamined Patent Publication No. 2010-267186
[Patent Document 4] PCT Japanese Translation Patent Publication No. 2005-525658

### DISCLOSURE OF THE INVENTION

The inventors found that some users have difficulty in treating a UI screen in which a large amount of information is simultaneously displayed on a display and other users have easiness in treating a UI screen in which a large amount of information is simultaneously displayed on a display. For example, some users have difficulty in understanding information when a large amount of information is simultaneously displayed on a display and thus processing efficiency or correctness thereof is lowered. On the other hand, other users can perform all input operations through only a direct input using a keyboard without the above-mentioned problem, thereby enhancing processing efficiency.

Here, in the techniques disclosed in Patent Documents 1 and 2, an amount of information (hereinafter, referred to as “display information”) to be simultaneously displayed on a display is changed by choosing information to be displayed on the UI screen according to a user.

In the techniques disclosed in Patent Documents 1 and 2, two UI screens having different amounts of display information are necessarily different from each other in information displayed on the corresponding UI screen. That is, a phenomenon may occur in which information included in one UI screen is not included in the other UI screen.

As described above, in the techniques disclosed in Patent Documents 1 and 2, there is a problem in that an amount of display information cannot be changed with identity in information to be displayed on a UI screen guaranteed.

The technique disclosed in Patent Document 3 is not configured to change an amount of display information. In the technique disclosed in Patent Document 4, it may be thought that an amount of display information can be changed by deleting information to be displayed on the UI screen, but a phenomenon may occur in which two UI screens having different amounts of display information is necessarily different from each other in the information to be displayed on the corresponding UI screen, similarly to the technique disclosed in Patent Documents 1 and 2.

Therefore, an object of the present invention is to provide a technique of adjusting the amount of information to be simultaneously displayed on a display with identity of information to be displayed on a UI screen guaranteed and designing a UI screen suitable for an assumed user. According to an aspect of the present invention, there is provided a UI creation support system that supports creating a UI screen for a predetermined service in which a plurality of user interface (UI) components are arranged, the UI creation support system comprising: UI configuration determining unit that determines a configuration of the UI screen, which includes all the plurality of UI components, for an assumed user using the UI screen according to the assumed user by adjusting the number of UI components to be simultaneously displayed on a display.

According to another aspect of the present invention, there is provided a UI creation support method of supporting creation of a UI screen for a predetermined service in which a plurality of UI components are arranged, the UI creation support method comprising: a UI configuration determining step of determining a configuration of the UI screen, which includes all the plurality of UI components, for an assumed user using the UI screen according to the assumed user by adjusting the number of UI components to be simultaneously displayed on a display.

According to still another aspect of the present invention, there is provided a program for supporting creation of a UI screen for a predetermined service in which a plurality of UI components are arranged, the program causing a computer to serve as a UI configuration determining unit that determines a configuration of the UI screen, which includes all the plurality of UI components, for an assumed user using the UI screen according to the assumed user by adjusting the number of UI components to be simultaneously displayed on a display.

According to the aspects of the present invention, it is possible to adjust the amount of information to be simultaneously displayed on a display with identity of information to be displayed on a UI screen guaranteed and to design a UI screen suitable for an assumed user.

### BRIEF DESCRIPTION OF THE DRAWINGS

The above-mentioned object and other objects, features, and advantages will become apparent with reference to the following exemplary embodiments and the accompanying drawings.

FIG. 1 is a functional block diagram illustrating an example of a UI creation support system according to an embodiment.

FIG. 2 is a diagram illustrating an example of a UI screen realized by the UI creation support system according to the embodiment.

FIG. 3 is a diagram illustrating an example of a UI screen realized by the UI creation support system according to the embodiment.

FIG. 4 is a diagram illustrating an example of a UI screen realized by the UI creation support system according to the embodiment.

FIG. 5 is a diagram illustrating an example of UI components held by a UI component holding unit according to the embodiment.

FIG. 6 is a flowchart illustrating an example of a process flow in a UI creating unit according to the embodiment.

FIG. 7 is a flowchart illustrating an example of a process flow of a UI creation support method according to the embodiment.

FIG. 8(a) is a diagram illustrating an example of a UI screen realized by the UI creation support system according to the embodiment.

FIG. 8(b) is a diagram illustrating an example of a UI screen realized by the UI creation support system according to the embodiment.

FIG. 8(c) is a diagram illustrating an example of a UI screen realized by the UI creation support system according to the embodiment.

FIG. 9(a) is a diagram illustrating an example of a UI screen realized by the UI creation support system according to the embodiment.

FIG. 9(b) is a diagram illustrating an example of a UI screen realized by the UI creation support system according to the embodiment.

FIG. 9(c) is a diagram illustrating an example of a UI screen realized by the UI creation support system according to the embodiment.

FIG. 9(d) is a diagram illustrating an example of a UI screen realized by the UI creation support system according to the embodiment.

FIG. 9(e) is a diagram illustrating an example of a UI screen realized by the UI creation support system according to the embodiment.

FIG. 9(f) is a diagram illustrating an example of a UI screen realized by the UI creation support system according to the embodiment.

### DESCRIPTION OF EMBODIMENTS

Hereinafter, embodiments of the present invention will be described with reference to the accompanying drawings.

Units in the embodiments are embodied by any combination of hardware and software based on a CPU and a memory of a computer, a program (including a program downloaded from a storage medium such as a CD or a server in the Internet or the like, in addition to a program stored in advance in the memory at the shipment thereof) loaded into the memory, a storage unit such as a hard disk storing the program, and a network access interface. It will be understood by those skilled in the art that the method and apparatus for embodiment thereof can be modified in various forms.

The functional block diagrams used to describe the embodiments does not show blocks of hardware units but blocks of functional units. In the drawings, each unit according to the embodiments are shown to be embodied by a single device, but the embodiment means thereof is not limited thereto. That is, the configurations may be divided physically or may be divided logically.

### First Embodiment

First, the summary of this embodiment will be described below.

In this embodiment, a display density (arrangement density) of UI components on a UI screen is adjusted according to an assumed user without changing (choosing) the UI components to be arranged on the UI screen. In order to arrange all predetermined UI components on a UI screen, the size (area) of the UI screen is adjusted according to the display density (arrangement density) of the UI components, and a scroll display function is introduced into the UI screen if necessary. In this embodiment, it is possible to change an amount of information to be simultaneously displayed on a display with identity of information to be displayed on a UI screen guaranteed.

According to this embodiment, it is possible to give support to an assumed user using a UI screen so as to customize the UI screen for himself or herself, as well as a designer of the UI screen so as to design the UI screen. The support details described herein are only an example and the present invention is not limited to this example.

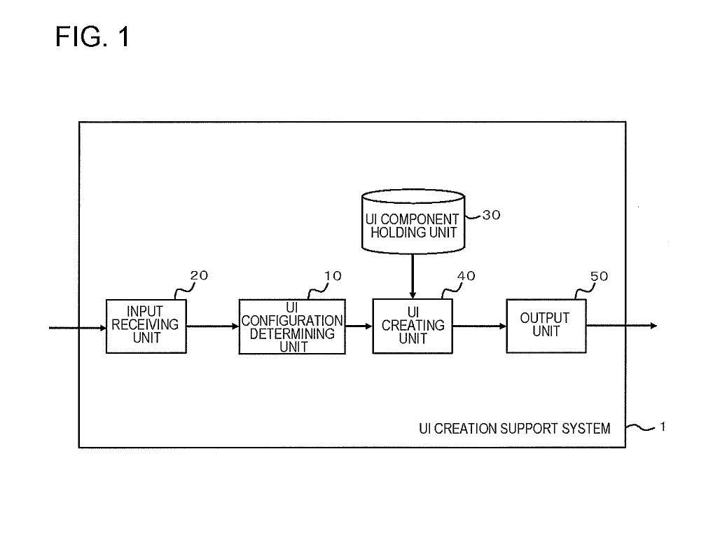

FIG. 1 is a functional block diagram illustrating an example of a configuration of a UI creation support system 1 according to this embodiment, as shown in the drawing, the UI creation support system 1 according to this embodiment includes a UI configuration determining unit 10. The UI creation support system 1 according to this embodiment may further include an input receiving unit 20, a UI component holding unit 30, a UI creating unit 40, and an output unit 50.

The UI creation support system 1 supports creating a UI screen for a predetermined service. The details of the predetermined service are not particularly limited. Plural UI components are arranged on the UI screen.

The “UI components” correspond to all components constituting a UI screen and include, for example, simple information having characters and figures displayed on the UI screen in addition to so-called GUI components (such as buttons and check boxes) for receiving an input from a user. The types and the number of UI components arranged on the UI screen are not particularly limited, and are design matters which can be determined on the basis of use scenes, usages, and the like of the UI screen.

The UI configuration determining unit 10 determines a configuration of the UI screen, which includes all the plurality of UI components, for an assumed user using the UI screen according to the assumed user by adjusting the number of UI components to be simultaneously displayed on a display.

The “UI components to be arranged on a UI screen” are UI components (hereinafter, referred to as “designed UI components”) which are determined to be arranged on the UI screen in designing the UI screen. What UI components to use as the designed UI components is design matters. The “UI components to be simultaneously displayed on a display” are UI components (hereinafter, “displayed UI components”) which are simultaneously displayed on a display displaying the UI screen, that is, UI components which can be simultaneously viewed by an assumed user. Depending on the size of a UI screen, the overall UI screen may be simultaneously displayed on the display or may not be simultaneously displayed. Accordingly, the displayed UI components include a part or all of the designed UI components.

In this embodiment, the UI configuration determining unit 10 adjusts the number of UI components to be simultaneously displayed on a display by adjusting the display density of the UI components on the UI screen according to the assumed user. Specifically, the UI configuration determining unit 10 decreases the number of UI components to be simultaneously displayed on the display by lowering the display density of the UI components on the UI screen according to the assumed user. The UI configuration determining unit 10 increases the number of UI components to be simultaneously displayed on the display by raising the display density of the UI components on the UI screen according to the assumed user.

The adjusting of the display density of the UI components on the UI screen can be performed, for example, by changing an arrangement rule of the UI components on the UI screen. The UI configuration determining unit 10 may determine the configuration of the UI screen for an assumed user by determining the arrangement rule of the UI components on the UI screen according to the assumed user.

The details of the arrangement rule of the UI components are not particularly limited, but examples thereof include a rule of defining the maximum number of UI components capable of being arranged in the same row on the UI screen, a rule of defining an interval between the UI components in the row direction on the UI screen, a rule of defining an interval between the UI components in the column direction, a rule of defining the intervals between the UI components in the row direction and the column direction, and a rule in which at least two rules of the above-mentioned rules are combined. For example, the specific values in the rules are design matters. For example, the UI configuration determining unit 10 may select one value out of predetermined plural candidate values according to an assumed user. The above-mentioned rules are only examples, and other rules may be used as long as they can adjusting the display density of the UI components.

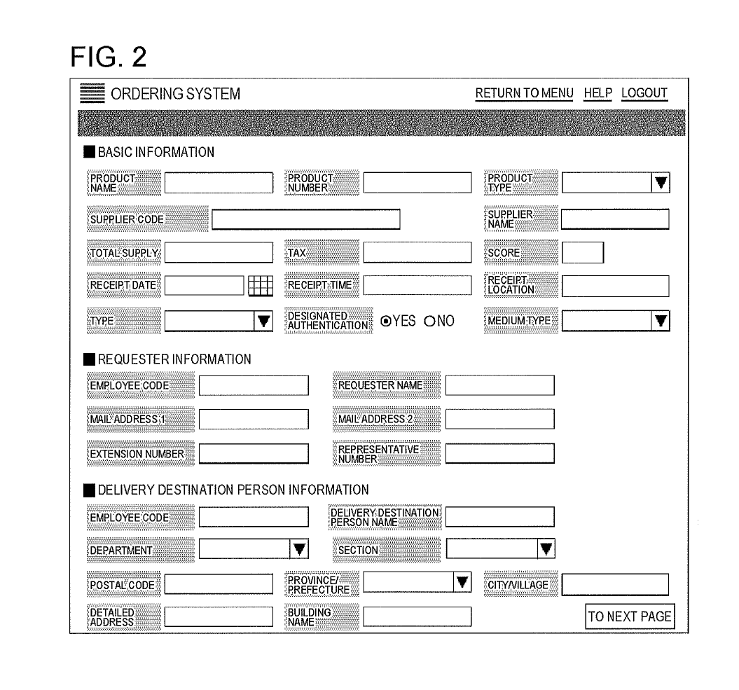

Here, examples of a UI screen in which plural UI components are arranged in accordance with different arrangement rules are shown in FIGS. 2 to 4. The UI screens shown in FIGS. 2 to 4 are displayed on a display.

The UI screen shown in FIG. 2 is a UI screen for an ordering system for inputting ordering data. In the UI screen, designed UI components including UI components such as “input box” and “radio buttons” for receiving a predetermined user input are arranged in addition to UI components including information such as “ordering system”, “basis information”, and “product name”. The UI screen shown in FIG. 2 is a UI screen (hereinafter, referred to as a “first UI screen”) in which all the designed UI components are simultaneously displayed on a display.

The UI configuration determining unit 10 can determine an arrangement rule of simultaneously displaying all the designed UI components on a display, like the first UI screen shown in FIG. 2, according to an assumed user.

The details of the arrangement rule of the first UI screen are not particularly limited, as long as a configuration in which all the designed UI components are simultaneously displayed on a display can be realized.

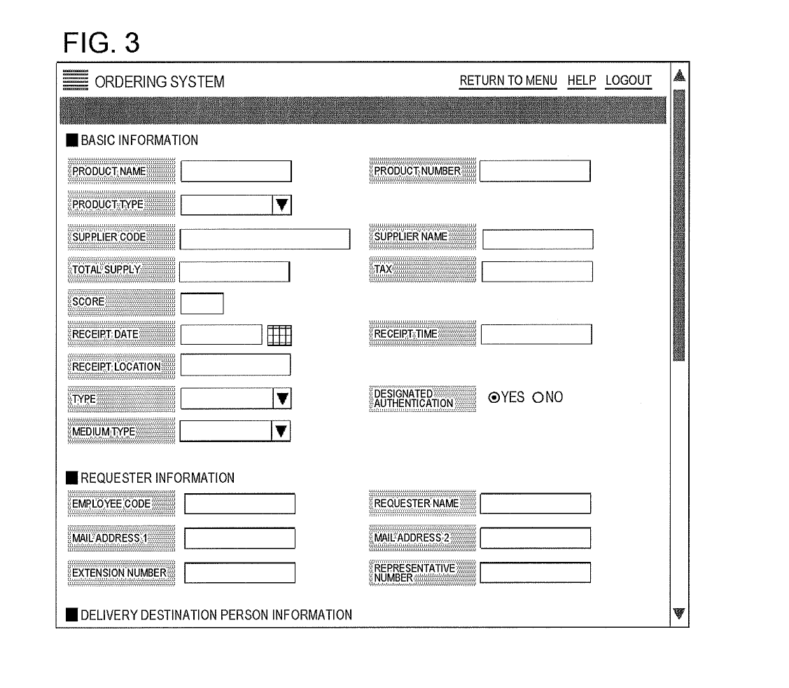

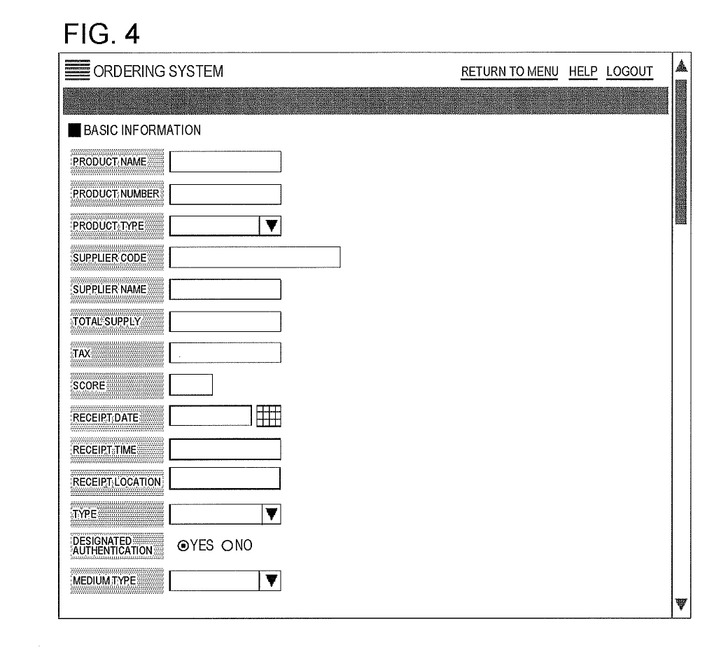

The UI screens shown in FIGS. 3 and 4 are UI screens (hereinafter, referred to as a “second UI screen”) in which the display density of the UI components is set to be smaller than the display density of the UI components in the first UI screen. The arrangement rules of the second UI screens shown in FIGS. 3 and 4 are smaller in the maximum number of UI components capable of being arranged in the same row than the arrangement rule of the first UI screen shown in FIG. 2. As a result, the second UI screens shown in FIGS. 3 and 4 are smaller in the display density of UI components than the first UI screen shown in FIG. 2 and thus the number of UI components simultaneously displayed on the display is also smaller. The second UI screen shown in FIG. 4 is smaller in the display density of UI components than the second UI screen shown in FIG. 3 and thus the number of UI components simultaneously displayed on the display is also smaller. That is, the arrangement rule of the second UI screen shown in FIG. 4 is smaller in the maximum number of UI components capable of being arranged in the same row than the arrangement rule of the second UI screen shown in FIG. 3.

The UI configuration determining unit 10 can determine an arrangement rule in which the display density of UI components is smaller than the display density of UI components on the first UI screen, like the second UI screens shown in FIGS. 3 and 4, according to an assumed user.

The arrangement rules of the second UI screens have only to realize the configuration in which the display density of UI components is smaller than the display density of UI components on the first UI screen, and the arrangement rule described with reference to FIGS. 3 and 4 are only examples.

Here, the designed UI components on the second UI screens shown in FIGS. 3 and 4 are the same as the designed UI components on the first UI screen shown in FIG. 2. The second UI screens shown in FIGS. 3 and 4 are larger than the first UI screen and thus a scroll display function is introduced.

The concept of “according to an assumed user” will be described below.

The term “according to an assumed user” may mean, for example, “according to a level of proficiency of an assumed user at a predetermined service”. In this case, the UI configuration determining unit 10 may determine the configuration of a UI screen so that the number of UI components to be simultaneously displayed on a display increases when the level of proficiency of an assumed user is high and the number of UI components to be simultaneously displayed on a display decreases when the level of proficiency of the assumed user is low.

In addition, the term “according to an assumed user” may mean, for example, “according to a level of proficiency of an assumed user at an apparatus (for example, a PC) for manipulating a UI screen”. In this case, the UI configuration determining unit 10 may determine the configuration of a UI screen so that the number of UI components to be simultaneously displayed on a display increases when the level of proficiency of an assumed user is high and the number of UI components to be simultaneously displayed on a display decreases when the level of proficiency of the assumed user is low.

In addition, the term “according to an assumed user” may mean, for example, a “frequency at which an assumed user utilizes a predetermined service”. In this case, the UI configuration determining unit 10 may determine the configuration of a UI screen so that the number of UI components to be simultaneously displayed on a display increases when the frequency of an assumed user is high and the number of UI components to be simultaneously displayed on a display decreases when the frequency of the assumed user is low.

The above-mentioned examples are only examples and the term “according to an assumed user” may have additional concepts.

Referring to FIG. 1 again, the input receiving unit 20 receives an input of information indicating attributes of an assumed user from the user. The information indicating attributes of an assumed user may be, for example, “information indicating a level of proficiency of the assumed user at a predetermined service” or “information indicating a level of proficiency of the assumed user at an apparatus (for example, a PC) for manipulating a UI screen”. This information may be, for example, information in which the level of proficiency of the assumed user is scored (for example, evaluated in five grades). In this case, the input receiving unit 20 may receive an input of a score indicating the level of proficiency of the assumed user from the user or may receive an input of information for calculating the score indicating the level of proficiency of the assumed user. The information for calculating the score indicating the level of proficiency of the assumed user may be information on the assumed user such as sex, age, service use time, and occupation of the assumed user. The input receiving unit 20 may calculate the score indicating the level of proficiency of the assumed user using a predetermined calculation rule stored in advance on the basis of the received information. A unit that causes the input receiving unit 20 to receive the input of information is not particularly limited, and can be realized using all input devices such as a keyboard, a mouse, and a touch panel display.

The information, an input of which is received by the input receiving unit 20, indicating attributes of the assumed user is sent to the UI configuration determining unit 10. Then, the UI configuration determining unit 10 determines the configuration of the UI screen corresponding to the assumed user on the basis of the information indicating the acquired attributes of the assumed user. For example, the UI configuration determining unit 10 may store in advance information in which the information (for example, score) indicating the level of proficiency of the assumed user and the information indicating the display density of UI components are correlated and may determine the configuration of the UI screen corresponding to the assumed user using the information.

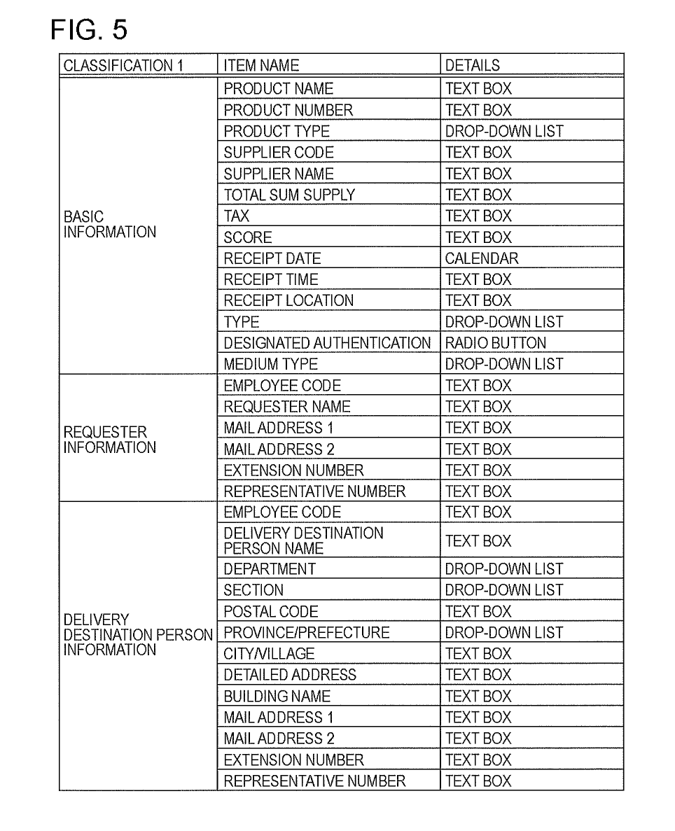

The UI component holding unit 30 holds the UI components (designed UI components) determined to be arranged on the UI screen in design of the UI screen. FIG. 5 shows an example of UI components held by the UI component holding unit 30. In the example shown in FIG. 5, GUI components for receiving an input from a user are described in a section of “details”. Information to be displayed on a UI screen in correlation with the GUI components is described in sections of “classification 1” and “item name”. For example, a text box described at the uppermost of the section of “details” is displayed in correlation with information of “basic information” and “product name” on the UI screen.

The UI creating unit 40 arranges the designed UI components to create a UI screen on the basis of the configuration (for example, arrangement rule) of the UI screen determined by the UI configuration determining unit 10 using the designed UI components held by the UI component holding unit 30. As a result, the UI screens shown in FIGS. 2 to 4 are obtained.

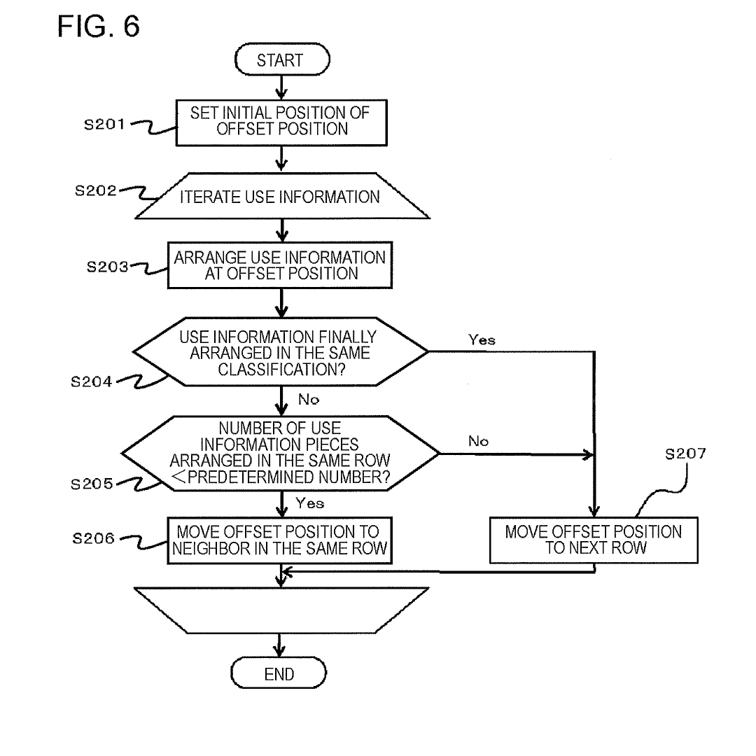

An example of a process flow of causing the UI creating unit 40 to create a UI screen will be described below with reference to the flowchart shown in FIG. 6.

As a whole, it is assumed that the UI creating unit 40 arranges the designed UI components shown in FIG. 5 and acquired from the UI component holding unit 30 on a UI screen. It is also assumed that the UI creating unit 40 arranges plural use information pieces on the UI screen from left to right and from up to down using one “item name” and “details” correlated with the “item name” shown in FIG. 5 as a set (hereinafter, referred to as “use information piece”). It is assumed that the UI creating unit 40 does not arrange the use information pieces correlated with different information of “classification 1” in the same row. It is also assumed that the UI creating unit 40 acquires an arrangement rule in which the maximum number of use information pieces capable of being arranged in the same rule from the UI configuration determining unit 10 is defined.

The above-mentioned assumptions are only an example, and this embodiment may have other configurations. For example, the order in which the use information pieces are arranged may be from right to left and from down to up. The arrangement rule may have other details.

A process flow of causing the UI creating unit 40 to arrange the use information pieces will be described below.

First, the UI creating unit 40 sets a position (hereinafter, referred to as “offset position”) at which the use information pieces are arranged on the UI screen as an initial position (S201). The initial position is set to a left end of an area located below an area (header area) in which page title, login name, help guidance information, and the like are displayed (see FIGS. 2 to 4), but is not limited to the position.

The UI creating unit 40 takes out each set of use information pieces out of the designed UI components shown in FIG. 5 in a predetermined order (design matters) and arranges the taken-out use information pieces on the UI screen (S202).

Specifically, the UI creating unit 40 arranges the taken-out use information pieces at the offset position (S203). Here, the GUI components specified by “item name” and “details” are arranged in this order from the left. Then, the UI creating unit 40 determines whether the use information piece arranged in the present time is the use information piece arranged finally out of the use information pieces correlated with classification 1 (S204).

When the determination result in S204 is YES, the UI creating unit 40 moves the offset position to the head of the next row (S207). That is, the x coordinate of the offset position is set to the value of the left end and the y coordinate is increased by one row. On the other hand, when the determination result is NO, the process flow goes to S205.

In S205, the UI creating unit 40 determines whether the number of use information pieces arranged in the row in which the use information piece is arranged is smaller than a predetermined number in a state where the use information piece is arranged in S203. The predetermined number is the maximum number of use information pieces capable of being arranged in the same row, which is specified by the arrangement rule acquired from the UI configuration determining unit 10 by the UI creating unit 40.

When the determination result in S205 is NO, the UI creating unit 40 moves the offset position to the head of the next row (S207). That is, the x coordinate of the offset position is set to the value of the left end and the y coordinate is increased by one row. On the other hand, when the determination result is YES, the UI creating unit 40 moves the offset position to the neighbor (in the same row) of the use information piece presently arranged (S206).

Thereafter, the UI creating unit 40 fully arranges all the designed UI components on the UI screen by repeating the processes of S203 to S207 until all the use information pieces held in the UI component holding unit 30 are arranged.

While the processes of arranging the use information pieces are mainly described above, a step of arranging information pieces of classification 1 may be employed at a predetermined timing.

Referring to FIG. 1 again, the output unit 50 outputs the UI screen created by the UI creating unit 40 through an output device such as a display. As a result, a user can view the UI screens shown in FIGS. 2 to 4.

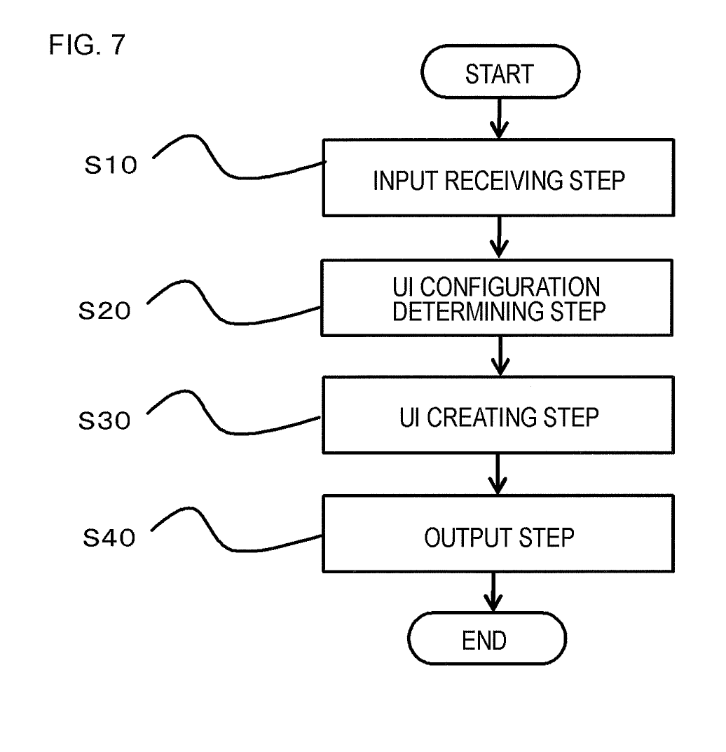

An example of a process flow of a UI creation support method according to this embodiment will be described below with reference to the flowchart shown in FIG. 7.

As shown in the flowchart of FIG. 7, the UI creation support method according to this embodiment includes an input receiving step S10, a UI configuration determining step S20, a UI creating step S30, and an output step S40.

In the input receiving step S10, the input receiving unit 20 receives an input of information indicating attributes of an assumed user from the user. For example, the input receiving unit 20 receives an input of “information indicating a level of proficiency of an assumed user at a predetermined service” (for example, evaluation in five grades).

In the UI configuration determining step S20, the UI configuration determining unit 10 determines a configuration of the UI screen, which includes all the plurality of UI components, for an assumed user using the UI screen according to the assumed user by adjusting the number of UI components to be simultaneously displayed on a display. For example, the UI configuration determining unit 10 determines the arrangement rule of the designed UI components on the UI screen for the assumed user on the basis of the “information indicating a level of proficiency of an assumed user at a predetermined service” (for example, evaluation in five grades).

In the UI creating step S30, the UI creating unit 40 creates a UI screen on the basis of the configuration of the UI screen determined by the UI configuration determining unit 10 in S20. For example, the UI creating unit 40 arranges the designed UI components in accordance with the configuration (for example, arrangement rule) of the UI screen determined by the UI configuration determining unit 10 using the designed UI components held in the UI component holding unit 30 and creates the UI screen. As a result, for example, the UI screens shown in FIGS. 2 to 4 are obtained.

In the output step S40, the output unit 50 outputs the UI screen created by the UI creating unit 40 in S30, for example, through the display.

Thereafter, for example, an input for storing the configuration of the UI screen output in step S40 may be received from the user and the information indicating the configuration of the UI screen may be stored. The information indicating the configuration of the UI screen may be data itself of the UI screen in which the designed UI components are arranged, or may be the arrangement rule determined by the UI configuration determining unit 10 in S20.

The UI creation support system 1 according to this embodiment can be realized, for example, by installing the following program in a computer:

A program for supporting creation of a UI screen for a predetermined service in which a plurality of UI components are arranged, the program causing a computer to serve as a UI configuration determining unit that determines a configuration of the UI screen, which includes all the plurality of UI components, for an assumed user using the UI screen according to the assumed user by adjusting the number of UI components to be simultaneously displayed on a display.

According to this embodiment, it is possible to adjust an amount of information to be simultaneously displayed on a display with identity of information to be displayed on a UI screen guaranteed and to design a UI screen suitable for an assumed user.

### Second Embodiment

First, the summary of this embodiment will be described below.

In this embodiment, a UI screen is divided into plural pages and UI components are displayed in the plural pages according to an assumed user without changing (choosing) the UI components to be arranged on the UI screen. In this embodiment employing this configuration, it is possible to adjust an amount of information to be simultaneously displayed on a display with identity of information to be displayed on a UI screen guaranteed.

According to this embodiment, it may be possible to give support to an assumed user using a UI screen so as to customize the UI screen for himself or herself, as well as a designer of the UI screen so as to design the UI screen. The support details described herein are only an example and the present invention is not limited to this example.

The functional block diagram illustrating an example of a configuration of a UI creation support system 1 according to this embodiment is the same as described in the first embodiment. That is, as shown in FIG. 1, the UI creation support system 1 according to this embodiment includes a UI configuration determining unit 10. The UI creation support system 1 according to this embodiment may further include an input receiving unit 20, a UI component holding unit 30, a UI creating unit 40, and an output unit 50.

The configurations of the UI configuration determining unit 10 and the UI creating unit 40 will be described below. The configurations of the input receiving unit 20, the UI component holding unit 30, and the output unit 50 are the same as described in the first embodiment and thus description thereof will not be repeated.

Similarly to the first embodiment, the UI configuration determining unit 10 can determine the configuration of the UI screen (first UI screen) in which all the designed UI components are simultaneously displayed on a display shown in FIG. 2 according to an assumed user as a configuration of a UI screen for the assumed user.

Similarly to the first embodiment, the UI configuration determining unit 10 can determine the configuration of the second UI screen in which the number of UI components to be simultaneously displayed on the display is smaller than that of the first UI screen according to an assumed user as a configuration of a UI screen for the assumed user. However, the configuration of the second UI screen determined by the UI configuration determining unit 10 according to this embodiment is different from the configuration of the second UI screen determined by the UI configuration determining unit 10 according to the first embodiment. This difference will be described below.

The UI configuration determining unit 10 according to this embodiment determines the configuration of the UI screen employing a display method of dividing the UI screen into plural pages and sequentially displaying the plural pages on the display as the configuration of the second UI screen. That is, the designed UI components are arranged in plural pages and the designed UI components are sequentially arranged on the display every predetermined number.

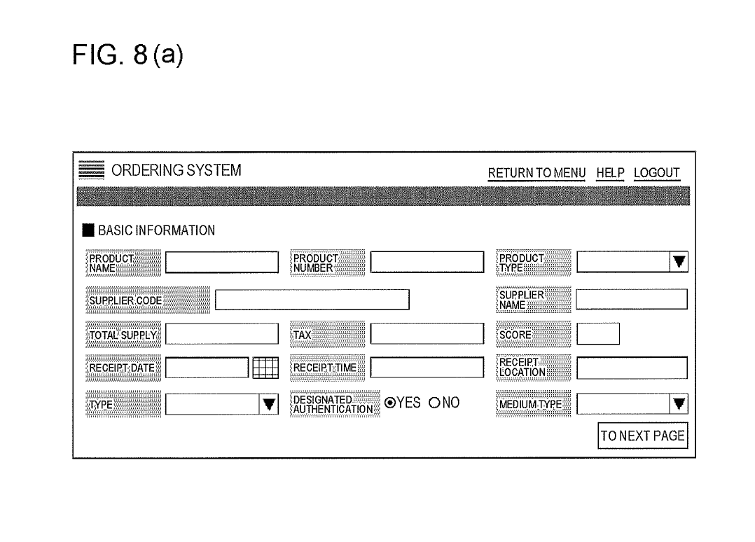

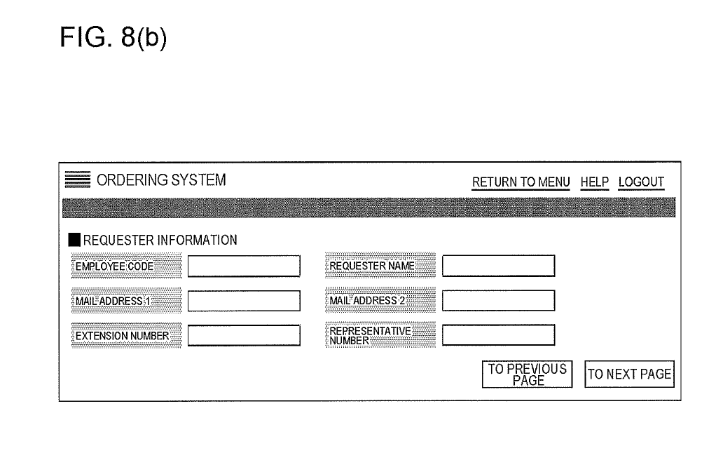

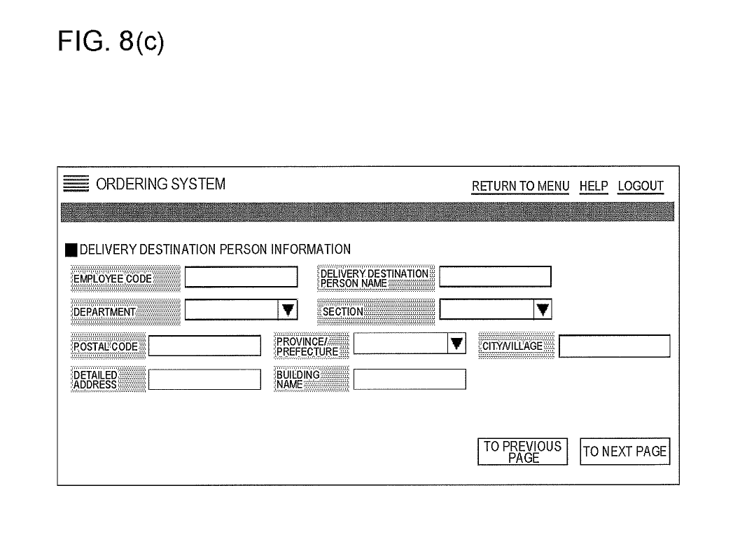

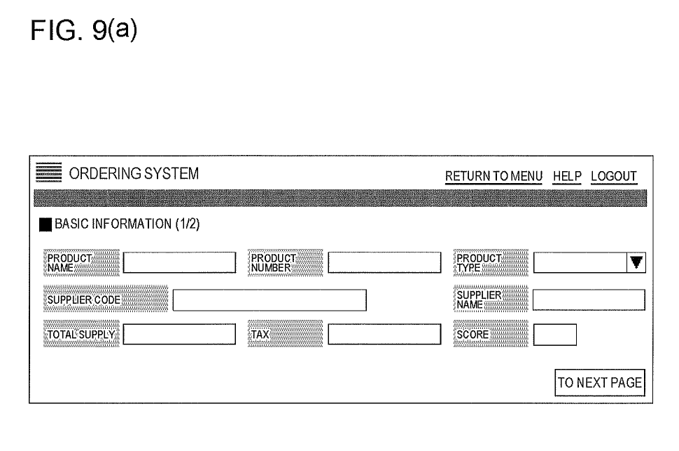

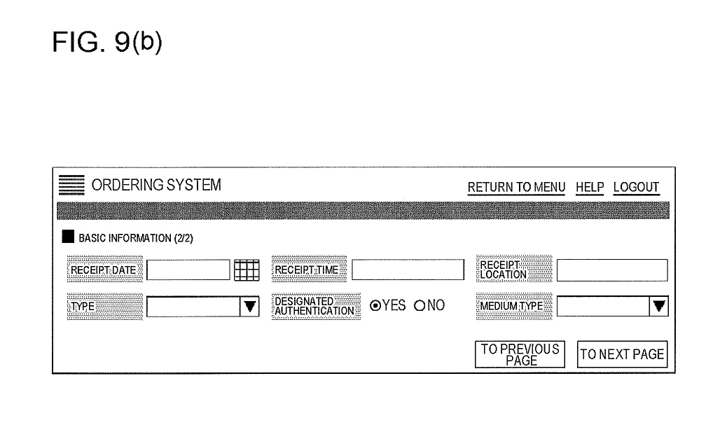

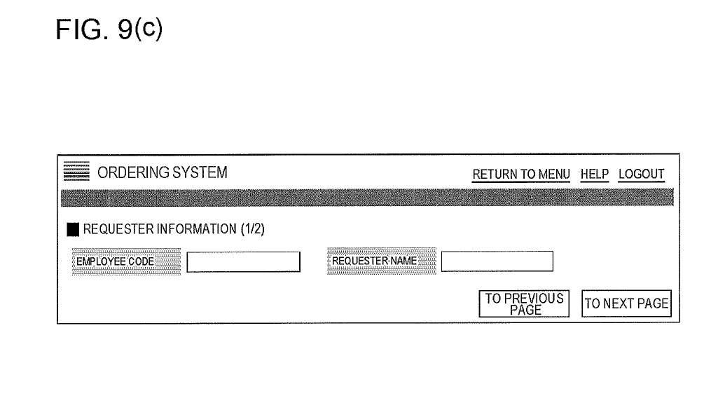

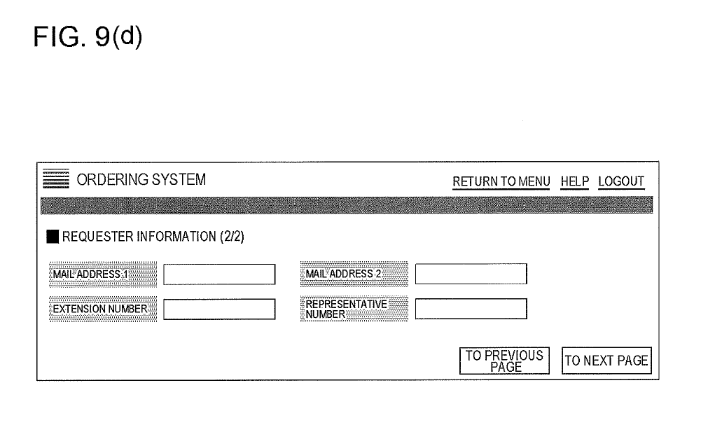

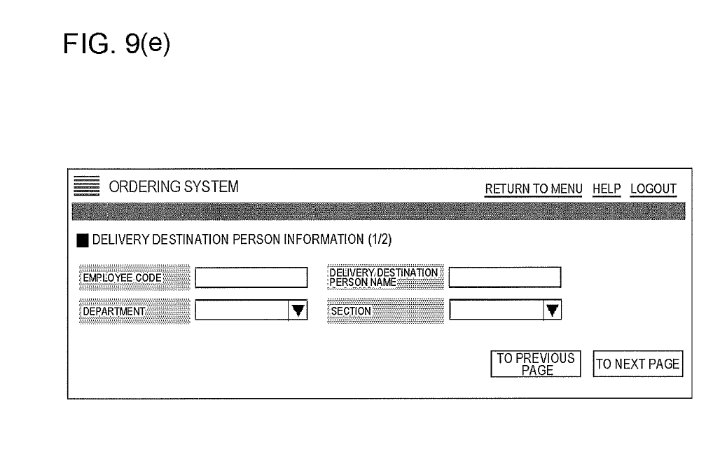

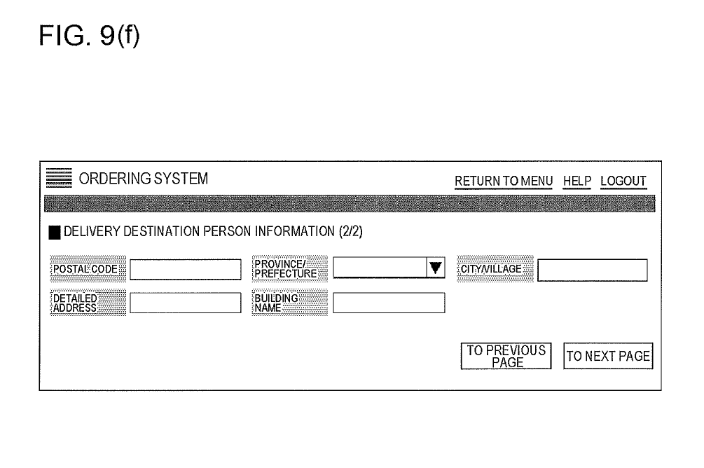

Examples of the configuration of the second UI screen determined by the UI configuration determining unit 10 according to this embodiment are shown in FIGS. 8(a) to 8(c) and FIGS. 9(a) to 9(f). A UI screen corresponding to the first UI screen shown in FIG. 2 is constructed by three pages shown in FIGS. 8(a) to 8(c). A UI screen corresponding to the first UI screen shown in FIG. 2 is constructed by six pages shown in FIGS. 9(a) to 9(f).

In the UI screen shown in FIGS. 8(a) to 8(c), the first UI screen shown in FIG. 2 is divided into the information units of classification 1 (see FIG. 5) of “basic information”, “requester information”, and “delivery destination person information” and each information unit is displayed in a single page. These plural pages are displayed on the display in a predetermined order in response to an input of buttons of “to next page” and “to previous page” disposed in each page. The arrangement method of UI components on the UI screens shown in FIGS. 8(a) to 8(c), that is, the number of UI components or the interval between the UI components arranged in the same row, is the same as the first UI screen shown in FIG. 2.

In the UI screen shown in FIGS. 9(a) to 9(f), each page of the UI screen shown in FIGS. 8(a) to 8(c) is further divided into two pages. Similarly, these plural pages are also displayed on the display in a predetermined order in response to an input of buttons of “to next page” and “to previous page” disposed in each page. The arrangement method of UI components on the UI screens shown in FIGS. 9(a) to 9(f), that is, the number of UI components or the interval between the UI components arranged in the same row, is the same as the first UI screen shown in FIG. 2.

Into what pages to divide the first UI screen and how to distribute the designed UI components to the pages are design matters.

The concept of “according to an assumed user” is the same as described in the first embodiment.

The UI creating unit 40 arranges the designed UI components to create a UI screen on the basis of the configuration of the UI screen determined by the UI configuration determining unit 10 using the designed UI components held by the UI component holding unit 30. As a result, the UI screens shown in FIG. 2, FIGS. 8(a) to 8(c), and FIGS. 9(a) to 9(f) are obtained.

The process flow of a UI creation support method according to this embodiment can be realized similarly to the first embodiment. Accordingly, description thereof will not be repeated.

According to this embodiment, it is possible to achieve the same operational advantages as the first embodiment.

The second UI screen of this embodiment is different from that of the first embodiment, in that the same arrangement method as the arrangement method of the UI components on the first UI screen (see FIG. 2) can be employed, as shown in FIGS. 8(a) to 8(c) and FIGS. 9(a) to 9(f).

In designing a UI screen, the arrangement method of the designed UI components may be fixed. For example, by matching an arrangement method of information pieces described in a payment slip or the like exchanged as a paper medium with an arrangement method of designed UI components corresponding to the information pieces described in the paper medium on a UI screen, it may be possible to achieve improvement in information input efficiency.

According to this embodiment, it is possible to adjust an amount of information to be simultaneously displayed on a display with identity of information to be displayed on a UI screen guaranteed and to design a UI screen suitable for an assumed user, even when the arrangement method of the designed UI components is fixed as described above.

### Third Embodiment

The functional block diagram illustrating an example of a configuration of a UI creation support system 1 according to this embodiment is the same as described in the first embodiment. That is, as shown in FIG. 1, the UI creation support system 1 according to this embodiment includes a UI configuration determining unit 10. The UI creation support system 1 according to this embodiment may further include an input receiving unit 20, a UI component holding unit 30, a UI creating unit 40, and an output unit 50.

The configurations of the UI configuration determining unit 10 will be described below. The configurations of the input receiving unit 20, the UI component holding unit 30, the UI creating unit 40, and the output unit 50 are the same as described in the first embodiment and thus description thereof will not be repeated.

In this embodiment, similarly to the first and second embodiments, the UI configuration determining unit 10 can determine the configuration of the UI screen (first UI screen) in which all the designed UI components are simultaneously displayed on a display shown in FIG. 2 according to an assumed user.

Similarly to the first and second embodiments, the UI configuration determining unit 10 can determine the configuration of the second UI screen in which the number of UI components to be simultaneously displayed on the display is smaller than that of the first UI screen according to an assumed user. However, the configuration of the second UI screen determined by the UI configuration determining unit 10 is different from the configuration of the second UI screen determined by the UI configuration determining unit 10 according to the first and second embodiment.

Specifically, the UI configuration determining unit 10 according to this embodiment determines the configuration of the UI screen employing a display method of dividing the UI screen into plural pages and sequentially displaying the plural pages on the display as the configuration of the second UI screen on the basis of the configuration of the second embodiment. That is, the designed UI components are arranged in plural pages and the designed UI components are sequentially arranged on the display every predetermined number.

The UI configuration determining unit 10 according to this embodiment adjust the arrangement method of the designed UI components distributed to each page on the basis of the configuration of the first embodiment as the configuration as the second UI screen. That is, the UI configuration determining unit 10 adjusts the display density of the UI components on the UI screen according to an assumed user. It is preferable that the display density be set to such a display density with which all the designed UI components of each page are simultaneously displayed on the display.

The concept of “according to an assumed user” is the same as described in the first embodiment.

The process flow of a UI creation support method according to this embodiment can be realized similarly to the first embodiment. Accordingly, description thereof will not be repeated.

According to this embodiment, it is possible to achieve the same operational advantages as the first embodiment.

Priority is claimed on Japanese Patent Application No. 2011-015235, filed on Jan. 27, 2011, the content of which is incorporated herein by reference.

1. A UI creation support system that supports creating a UI screen for a predetermined service in which a plurality of user interface (UI) components are arranged, the UI creation support system comprising:
UI configuration determining unit that determines a configuration of the UI screen, which includes all the plurality of the UI components, for an assumed user using the UI screen according to the assumed user by adjusting the number of the UI components to be simultaneously displayed on a display.

2. The UI creation support system according to claim 1, wherein the UI configuration determining unit determines a configuration in which a display density of the UI components in the UI screen is smaller than the display density of a first UI screen as a configuration of a second UI screen which is simultaneously displayed a smaller number of the UI components on the display than the first UI screen which is capable of being simultaneously displayed all the plurality of the UI components on the display.

3. The UI creation support system according to claim 2, wherein the UI configuration determining unit determines a configuration with a scroll display function as the configuration of the second UI screen.

4. The UI creation support system according to claim 1, wherein the UI configuration determining unit determines a configuration with a display function which divides the UI screen into a plurality of pages and sequentially displays the plurality of pages on the display as the configuration of the second UI screen which is simultaneously displayed a smaller number of the UI components on the display than the first UI screen which is capable of being simultaneously displayed all the plurality of the UI components on the display.

5. The UI creation support system according to claim 1, wherein the UI configuration determining unit
decreases the number of the UI components to be simultaneously displayed on the display when a level of proficiency of the assumed user at the predetermined service is low, and
increases the number of the UI components to be simultaneously displayed on the display when the level of proficiency of the assumed user at the predetermined service is high.

6. A UI creation support method of supporting creation of a UI screen for a predetermined service in which a plurality of the UI components are arranged, the UI creation support method comprising:
a UI configuration determining step of determining a configuration of the UI screen, which includes all the plurality of the UI components, for an assumed user using the UI screen according to the assumed user by adjusting the number of the UI components to be simultaneously displayed on a display.

7. An non-transitory storage medium storing a program for supporting creation of a UI screen for a predetermined service in which a plurality of the UI components are arranged,
the program causing a computer to serve as a UI configuration determining unit that determines a configuration of the UI screen, which includes all the plurality of the UI components, for an assumed user using the UI screen according to the assumed user by adjusting the number of the UI components to be simultaneously displayed on a display.
